(19) United States
(12) Patent Application Publication
(10) Pub. No.: US 2005/0019222 A1
(43) Pub. Date: Jan. 27, 2005

(54) Device and method for preparing particles for analysis

(76) Inventor: Anthony John Medland, Bradford on Avon (GB)

Correspondence Address: Ronald R Santucci;Frommer Lawrence & Haug, 745 Fifth Avenue, New York, NY, 10151, US

(21) Appl. No.: 10/495,418

(22) PCT Filed: Nov. 14, 2002
(86) PCT No.: PCT/GB02/05148

(30) Foreign Application Priority Data
Nov. 14, 2001 (GB) 0127360.6

(51) Int. Cl. B01L 3/02

(52) U.S. Cl. 422/100

(57) ABSTRACT

A device (1) for laying down particles, for example, cells, on a substrate for subsequent examination thereof comprises a porous substrate (117) and delivery means for delivering to the porous substrate (117) a sample of fluid that contains the particles, the delivery means comprising an inlet (6, 7a, 7b, 7c) for the fluid, and a passageway (11) extending along a first direction from the inlet towards the porous substrate (117), the passageway (11) being so arranged that it permits flow of the fluid generally along a first direction towards the substrate (117) whilst further permitting spreading of then fluid in a direction transverse to the first direction.

The invention relates to the extraction of particulate materials from a fluid medium for analysis. In particular, the invention relates to a device and method for preparing particulate material, especially cells, on a substrate for examination.

Samples are routinely taken from tissue and bodily fluids of humans and animals for use in diagnosis. Certain samples are prepared on glass or plastic microscope slides, which are then examined visually with a microscope. Particularly in the case of screening programmes, laboratories are responsible for examining large numbers of samples. Such examinations, which must be carried out by skilled personnel, are partly subjective in nature, are labour-intensive, and by their nature prone to human error.

One important area which relies on cytological examination is screening for cancer of the cervix in women. Currently, detection of cervical cancer and pre-cancer is carried out using the Papanicolau or PAP test (widely known as the “cervical smear test.”), in which a sample, or smear, taken from the cervix is applied onto a slide. The cells, which are stained using appropriate dyes, are then examined to assess whether they appear normal. The efficiency of the highly skilled task of examining the slides to distinguish between normal and abnormal smears is currently limited by a large number of slides which are inadequate and hence cannot form a valid basis for diagnosis. For example, the objective is to ensure that the sample taken from the patient contains not only cells from the squamous epithelium, which is located at the exterior of the cervical opening (exocervix), but also cells from the columnar epithelium, which extends into the endocervical canal (endocervix) and cells from the transformation zone between the exocervix and endocervix. The majority of malignant tumours arise in the vicinity of the squamo-columnar junction, and the occurrence of the columnar cells and transformation zone cells in the sample is considered to indicate that the squamo-columnar junction has been effectively sampled. Slides upon which the columnar cells and transformation zone cells are not observable, or are observable only in insufficient numbers, are considered inadequate.

Other slides may be inadequate because the sample has been incorrectly applied to the slides such that there are two few, or too many, cells, or such that non-diagnostic material obscures diagnostic material.

The inadequate slides are only identified when subjected to visual examination, so that valuable resources are wasted.

Other diagnostic techniques currently carried out which involve the use of cytological examination include breast cancer screening, screening for cancers of the thyroid, lung or ovaries, and examination of bodily fluids, including, for example, sputum, pleural and peritoneal fluids and blood.

The present invention provides a device for laying down particles on a substrate, comprising a porous substrate and delivery means for delivering to the porous substrate a sample of fluid that contains the particles, the delivery means comprising an inlet for the fluid, and a passageway extending along a first direction from the inlet towards the porous substrate, the passageway being so arranged that it permits flow of the fluid generally along a first direction towards the substrate whilst further permitting spreading of the fluid in a direction transverse to the first direction.

The invention also provides a device for preparation of a layer of particles for subsequent optical examination, comprising a slide member enclosing a flow arrangement which includes a porous substrate at least a substantially planar upper surface of which extends substantially horizontally within and along a portion of the slide member, the flow arrangement further comprising an inlet for a fluid sample that contains the particles, and a passageway extending from said inlet for delivery of the sample onto said upper surface of said porous substrate.

The device of the invention allows for the separation of particles from a fluid in which they are suspended, and for preparation of a substrate carrying a thin covering of the particles. In particular, the device of the invention can allow a relatively small volume of liquid to come into contact with a relatively large area of substrate. The device permits there to be generated a loaded substrate having a loading region that can easily be scanned automatically. It is also possible to avoid wastage of cells that can occur in loading a larger area of substrate. The device offers the possibility of laying down the cells relatively evenly, and advantageously substantially in a monolayer.

It will be appreciated that the terms “horizontally” and “upper” are used above in the context of the device when in use.

Where, as is preferred, the particles are in use of the device marked by suitable markers, the device permits there to be generated a loaded substrate which can be examined by any suitable visualisation technique, thereby allowing examination, evaluation or characterisation of the particles in any one or more of a variety of ways.

“Visualisation techniques” as used herein includes both techniques using an optical instrument, such as an optical microscope, and other techniques which employ suitable forms of radiation such as UV scanning, electron microscopy, photographic and colour discrimination techniques.

In the clinical area, the device of the invention offers the possibility of a simple and reliable test for the adequacy of a sample of cells taken, which can be carried out quickly and without the involvement of the specialist personnel conventionally involved in cytological examination. As a result, the wastage of resources attributable to inadequate samples could be substantially reduced. Furthermore, in many cases, for example in screening for cervical cancer, it may be possible for the adequacy of the sample to be assessed during attendance of the patient to provide the sample. Where the sample is inadequate, that could enable a new sample to be taken without the need for recall of the patient, thereby in principle-permitting an earlier assessment of whether the sample is abnormal, and thus an early indication that further investigation by a suitable specialist may be appropriate. The possibility of an immediate and simple test for adequacy may be of particular assistance in the training of clinical staff to take smears effectively, but it is furthermore envisaged that the device of the invention could in principle form the basis of screening for cervical cell abnormality, complementing or replacing the currently widely-used PAP test.

Other clinical areas in which use of the device of the invention is in particular envisaged include blood cell counting, breast cancer screening, screening for cancers of the thyroid, lung or ovaries, and screening for abnormal cells in bodily fluids including, for example, sputum, pleural and peritoneal fluids and blood. The device may, however, find usage in any clinical area in which clinically relevant information is obtainable from human or animal cells.

The device may also be used in non-clinical areas, for example, quality control in polymer manufacture, in food manufacture (for example in the analysis of wheat and potato starches), in beverage manufacture (for example in the analysis of yeast viability), in the pharmaceutical industry (for example, for analysis of the viability of cells), in the petrochemical industry, in the monitoring of effectiveness of particle removal in filtration processes in a variety of manufacturing processes and in waste treatment, in the analysis of soil, minerals, ore and geothermic fluids, and in the analysis of water (for example, of suspensions of algae, plankton and marine sediments). In general, the device is suitable for separating particles of diameters of not more than 2 mm from a fluid in which they are suspended. In many cases, however, the particles to be separated will be smaller, for example of 50 μm or less.

Advantageously, at least a part of the passageway is flared outwardly. Preferably, the passageway comprises an outlet communicating with the porous substrate for delivery of the sample thereto, and at least that part of the passageway that is in the vicinity of the outlet is flared outwardly.

Advantageously, the porous substrate extends substantially parallel to an upper surface of the device and the arrangement is such that the passageway can deliver the sample on to the porous substrate from above. That arrangement is advantageous in that it can give improved viewing of the substrate through the upper surface. It will be appreciated that it is not important for that purpose for all parts of the upper surface to be parallel to the substrate, but merely those in the vicinity of the substrate. At least in the vicinity of the substrate, the parallel upper surface preferably has good optical transmissivity.

Advantageously, the porous substrate is oriented such that, when in suitable viewing apparatus, it is substantially horizontal.

Provided that excessive pressure is not applied to the fluid, it has been found that on a substantially horizontal surface the fluid spreads transversely under the influence of its surface tension to extend across the width of the flared portion of the passageway, contacting the diverging walls along at least most of their length.

In one form of the invention, the fluid enters the device and passes through the device under the force applied by virtue of the mass of the remainder of the fluid sample bearing down upon the device inlet. Thus, it has been found in the use of a device for laying down cells that the application of external pressure may be unnecessary. If desired or necessary, however, transport of the fluid through the device may be assisted by an applied positive or negative pressure. Such an applied pressure may be preferred or necessary for example, in cases where the size and/or frequency of the apertures in the porous substrate are small, where the size and/or concentration of particles in the fluid is high, or where significant aggregation of particles is encountered.

As already mentioned, the passageway through which the fluid passes in the delivery means comprises at least a portion that is flared outwardly. The arrangement is preferably such that the walls of the passageway each extend outwardly at an angle of at least 40° to the longitudinal axis of the passageway, that is, the angle subtended by two flared walls may be at least 80°. In practice, it has been found that the degree of flare can be varied significantly without detriment to the successful operation of the device. In general, however, the angle subtended by the two flared walls will be not more than 160°.

The term “flared” is used herein to include both arrangements which are flared by reason of having divergent walls, each of which is straight, and arrangements which are flared by reason of having divergent walls which are not straight, for example, which are curved or which each consist of two or more portions (each of which may be straight or curved) separated by a discontinuity.

The length of the flared portion of the passageway will depend upon the application for which the device is to be used. It will generally be not more than 5 cm. For devices for use in the laying down of cells, it may advantageously be not more than 3 cm, for example, from 1 to 3 cm.

The selection of appropriate degrees of flaring and lengths will be a matter of routine experiment, having regard to the nature of the fluids and particles to be used in the device, and the configuration and dimensions of the porous substrate upon which the particles are to be delivered.

The outlet is advantageously positioned above the porous substrate in use of the device. Preferably, the outlet is positioned substantially vertically above the porous substrate in use of the device. Advantageously, the passageway for the fluid includes a wall that extends towards the porous substrate, whereby the porous substrate can receive fluid which, in use, flows from the passageway via the wall. Advantageously, the wall extends downwardly in use of the device. Preferably, the wall is of elongate configuration, having a longitudinal dimension that is greater than a transverse dimension, the wall being so located that its longitudinal dimension extends generally transversely to the direction of flow of the fluid down the wall. Advantageously, the passageway comprises a base that terminates at the wall. Advantageously, the passageway further comprises opposed side walls that diverge from one another along at least a part of the passageway in the direction in which, in use, the fluid flows. Preferably, the delivery means is enclosed. Advantageously, there is a drainage receptacle for receiving fluid that has passed through the porous substrate. Advantageously, the device further comprises a reagent-delivery channel through which a reagent can be delivered into the delivery means. Preferably, the device comprises from two to six reagent-delivery channels through each of which a reagent can be delivered into the delivery means. Advantageously, the or each reagent-delivery channel communicates with a respective access opening through which reagent can be introduced into the device.

In use of the device for laying down cells, the cells, together with other accompanying endogenous material taken from a human or animal subject, may be introduced into a fixative solution of a kind well known in the field of histology. Typical fixative solutions include those containing alcohol and water in a ratio of about 40:60, with the optional presence of other compounds. In the use of the device of the invention additional ingredients may include, for example, surfactants.

Furthermore, in use of the device for laying down cells, there may be present one or more substances for assisting in the evaluation of the cells supported on the substrate, for example, the device may comprise a selective binding moiety, the arrangement being such that in use the fluid can contact the selective binding moiety before it is delivered to the porous substrate. The selective binding moiety is preferably a moiety which is capable of selectively binding to a group or groups of target cells thereby permitting the target cells to be distinguished from other cells present on the substrate. Selective binding moieties that may be used will include in particular antibodies, especially monoclonal antibodies and including antibody fragments, derivatives, functional equivalents and homologues of antibodies; antigens; hormones; and any other protein capable of recognising and binding to the target cell or cells or a non-proteinaceous compound having binding capacity specific for the target cell or cells. Suitable moieties include, for example, any of the polypeptides comprising an immunoglobulin binding domain described in WO 98/05967.

Advantageously, the selective binding moiety is in combination with marker means for acting as an indicator of any selectively bound binding moiety that is retained upon the porous substrate in use of the device. In that way, the reactivity of the selective binding moiety (and thus relevant characteristics of the sample, such as the proportion of cells of a certain kind) may be monitored.

Suitable marker means, include:
(1) Linking to a dye (chromogen) having spectrally distinct absorption and emission characteristics, for example, a fluorochrome, phosphor or laser dye.
(2) Supporting the moiety on a particulate material, such as latex beads that have been rendered coloured, magnetic or paramagnetic.
(3) Tagging with reporter molecules which directly or indirectly generate signals which are detectable, and preferably measurable. The reporter molecules may be directly or indirectly bound to the binding moiety, by covalent or non-covalent bonding.

The marker means mentioned in (1) to (3) above will generally be combined with the binding moiety before the binding moiety is introduced into the device. The use of selective binding moieties, for example, antibodies, will enable quantitative estimates of the binding to be made, which may provide useful diagnostic information. If desired two or more selective binding moieties and associated respective markers may be used, each being suitable for binding to a different group of target cells, and permitting those groups of target cells to be distinguished from one another, as well as from other cells. With choice of suitable marker means, it will be possible to record images of the substrate with the supported cells, allowing preservation and subsequent re-evaluation of the results. Advantageously, the marker means will be such that an image of the cells on the substrate can be scanned using suitable imaging means, and stored, preferably electronically. It will be appreciated that at least a portion of the device covering the substrate should be constructed of a material that transmits the radiation utilised in the examination technique of choice. For example, where the device is to be examined under a microscope, the device should be constructed at least in part of an optically suitable material. Polycarbonate has been found to be a suitable material.

The selective binding moieties and/or other substance(s) for assisting in the evaluation of the supported cells may be incorporated into the device before introduction of the sample. For example, they may be incorporated into the device during manufacture thereof. In that case, they may advantageously be incorporated into the reagent delivery channels referred to above. As well, or instead, the binding moieties or other substances may be introduced into the device simultaneously with, and/or after, the sample.

In general, the device will have a total internal void volume of not exceeding 20 ml. Advantageously, the device has a total internal void volume not exceeding 4 ml. Advantageously, the internal void volume of the device upstream of the porous substrate is not more than 1 ml, and preferably not more than 0.5 ml. More preferably, the internal void volume of the device upstream of the porous substrate is not more than 0.4 ml. Advantageously, the delivery means has an outlet of width at least 10 mm, and preferably at least 20 mm. The outlet of the delivery means advantageously has a height of not more than 4 mm, and preferably not more than 3 mm.

The device may further comprise a fluid container, the delivery means and the substrate being located within a member that can be attached to the fluid container. In that case, the arrangement is preferably such that a fluid sample from the container can be introduced into the delivery means by means of partially or wholly inverting the container and member.

The device may comprise a membrane through which a fluid sample can be injected into the device.

Advantageously, the porous substrate has pores of diameter not more than 50 μm, for example not more than 25 μm. Preferably, the pore size is in the range of from 0.05 to 20 μm. In the case of many clinical applications, it is preferred for the pore size to be in the range of from 1 to 15 μm, especially from 2 to 10 μm. For separating cells from a cervical smear sample, a suitable pore size has been found to be from about 5 to about 10 μm, for example, about 8 μm. In some applications, it may be preferred for the pore size to be in the range of from 10 to 20 μm.

Advantageously, at least that part of the device containing the passageway and that part of the porous substrate upon which the cells are to be laid down is transparent to radiation. Advantageously, the device is so dimensioned and configured that at least that part of the device that in use will contain the loaded porous substrate can be inserted into a sample cavity of an instrument for analysis of the cells using radiation. Advantageously, the device is so dimensioned and configured that at least that part of the device that in use will contain the loaded porous substrate can be inserted into the viewing region of a device for visual inspection, for example, a microscope. Advantageously, the device comprises a filter for filtering a sample of fluid that is to enter the delivery means. The filter is advantageously suitable for removing from the fluid particles of diameter 200 μm or more, and preferably particles of diameter 50 μm or more. In some circumstances, it may be advantageous for the filter to be suitable for removing particles of diameter 20 μm or more. In that case it will be appreciated that the pore size of the porous substrate will be smaller, for example, not more than 10 μm.

The invention further provides a slide for use in the separation of particles from a fluid, the slide enclosing a separation labyrinth comprising a fluid inlet for receiving a sample of fluid containing the particles, a porous substrate, and a fluid pathway communicating between the fluid inlet and the porous substrate for the passage of fluid.

Moreover, the invention provides a method of laying down particles comprising passing a sample of fluid along a path that flares outwardly permitting the flow of fluid so obtained to fall onto an upper face of a porous substrate and draining away from a lower face of the porous substrate residual fluid that has passed therethrough. Furthermore, the invention provides a method of laying down particles on a substrate, in which a sample of fluid of volume not exceeding 0.5 ml is brought into contact with a porous substrate over an area of at least 20 mm².

The device of the invention is relatively simple in construction, and advantageously may be suitable for single usage.

Two embodiments of the invention will now be described, by way of example, with reference to the accompanying drawings in which:

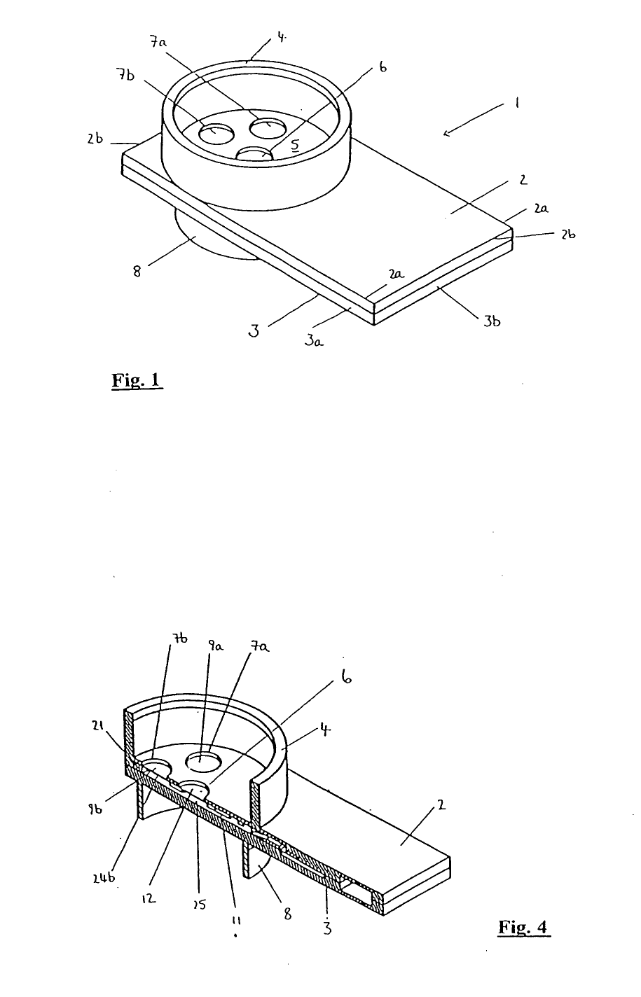

FIG. 1 is a perspective view from above of the device;

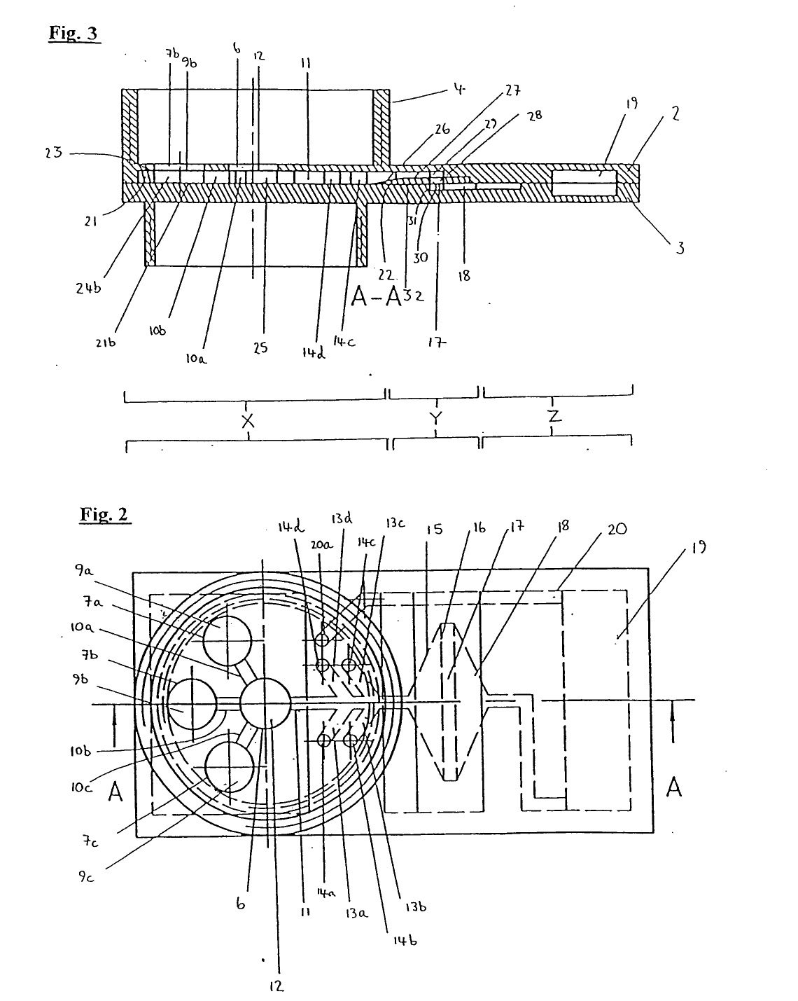

FIG. 2 is a plan view from above;

FIG. 3 is a section through A-A in FIG. 2;

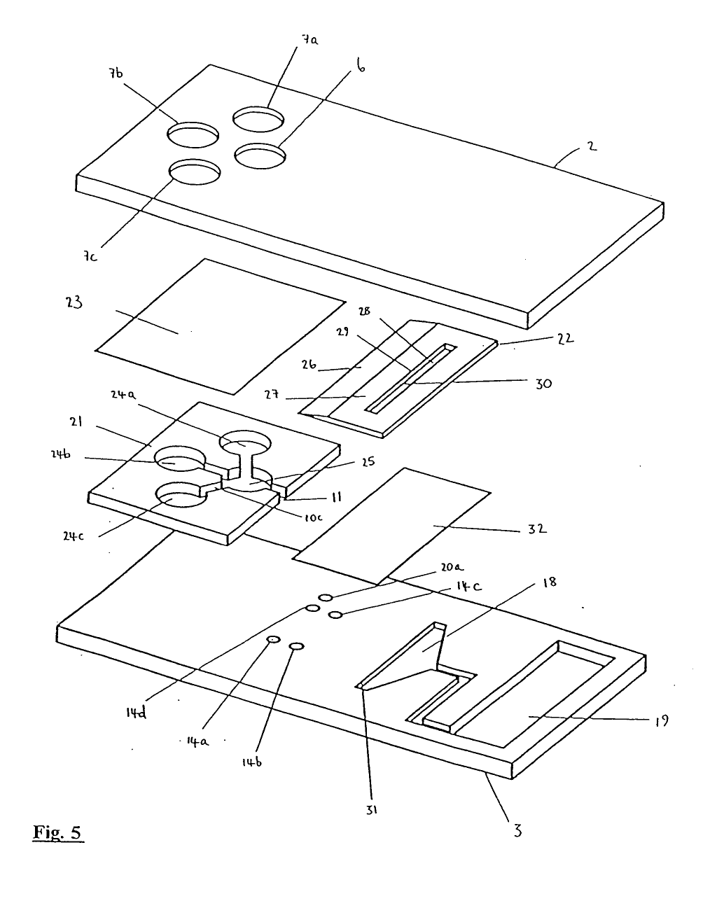

FIG. 4 is a perspective view from above, partly in section.

FIG. 5 is an exploded view of the device;

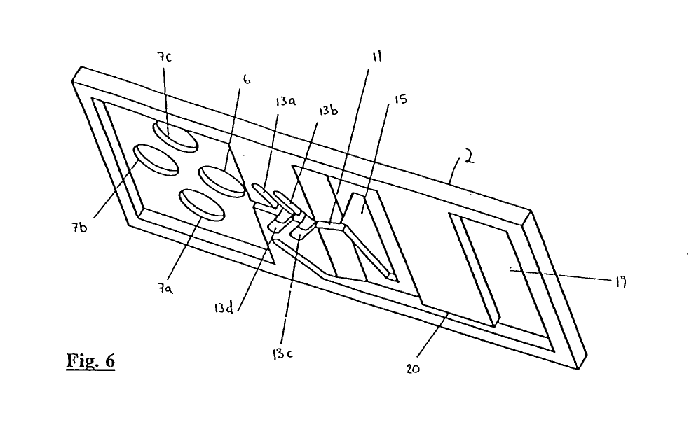

FIG. 6 is a perspective view from below of a first member of the device;

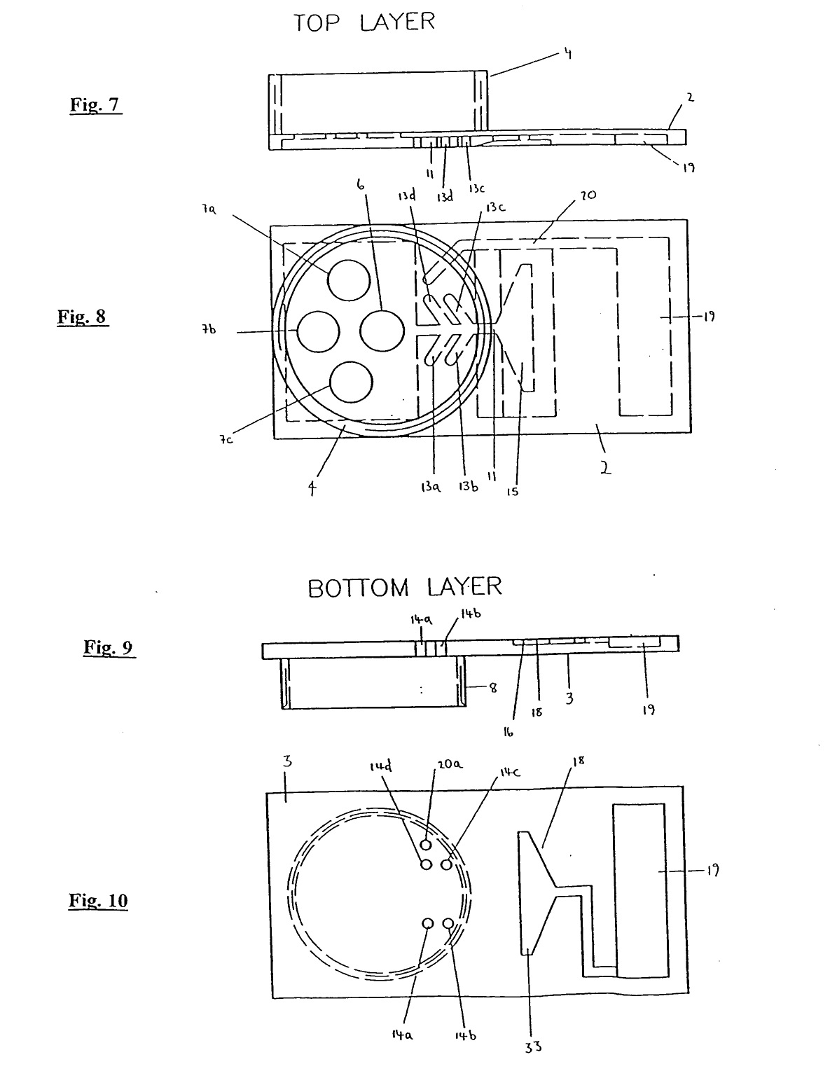

FIG. 7 is a side view of the first member of the device;

FIG. 8 is a plan view of the first member of the device;

FIG. 9 is a side view of a second member of the device;

FIG. 10 is a plan view of the second member of the device;

FIG. 11 is a plan view of a first insert for inclusion between the-first member and the second member;

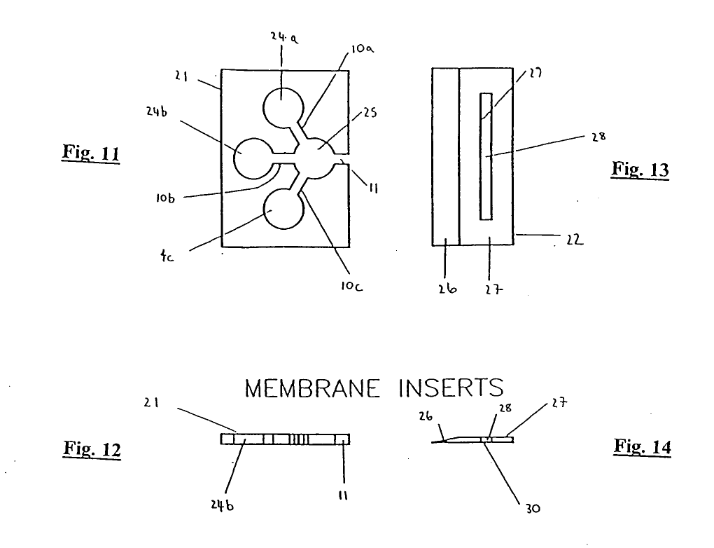

FIG. 12 is a side view, partly in section, of the first insert;

FIG. 13 is a plan view of a second insert for inclusion between the upper piece and the lower piece;

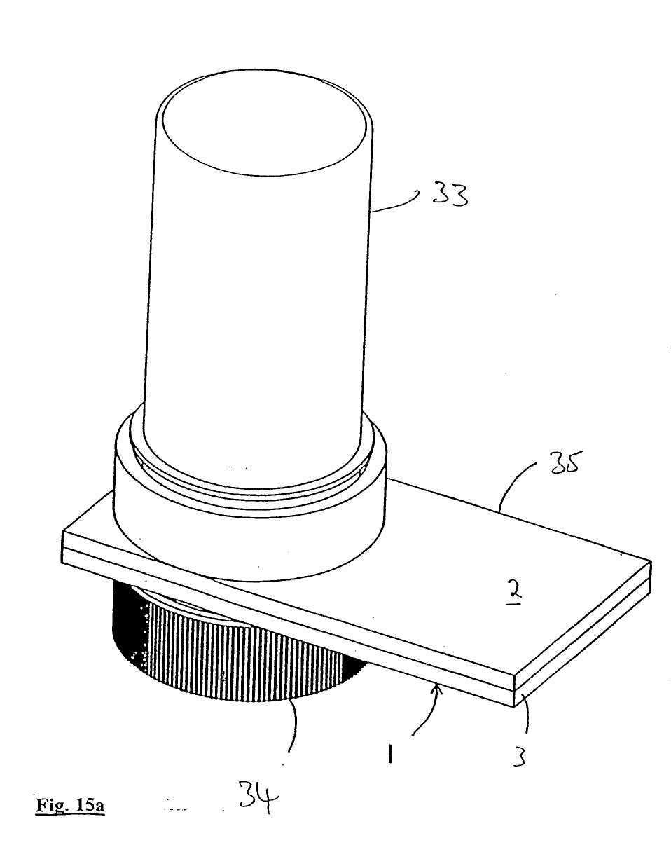

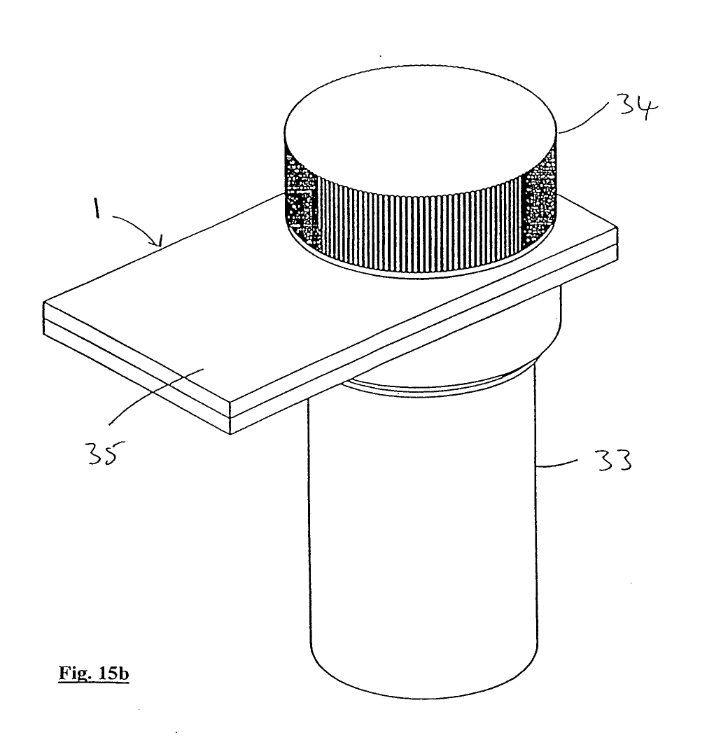

FIG. 14 is a side view, partly in section, of the second insert;

FIG. 15a is a perspective view of the device of FIG. 1 with a container and lid;

FIG. 15b is a further view of the device and container of FIG. 15a;

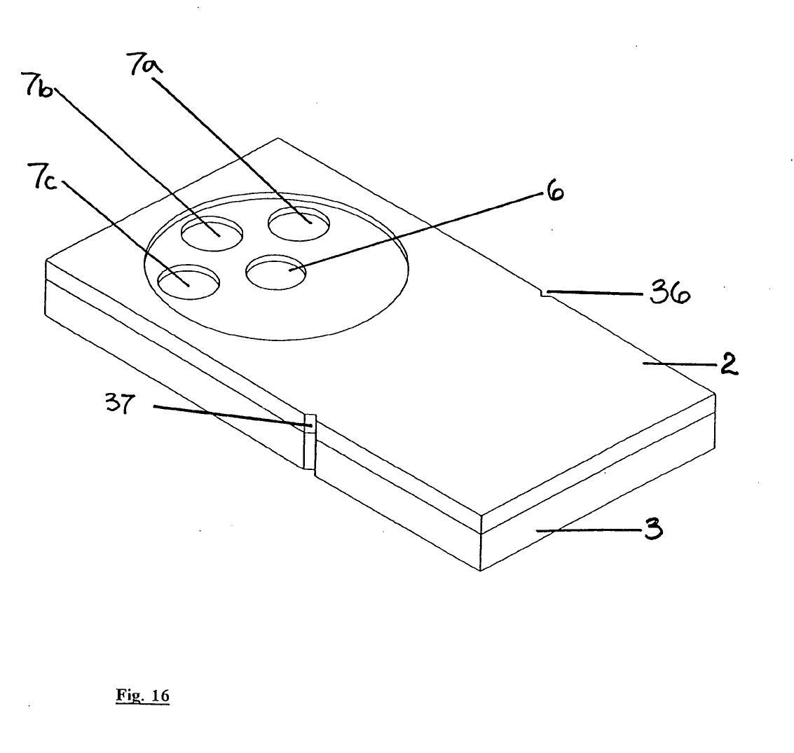

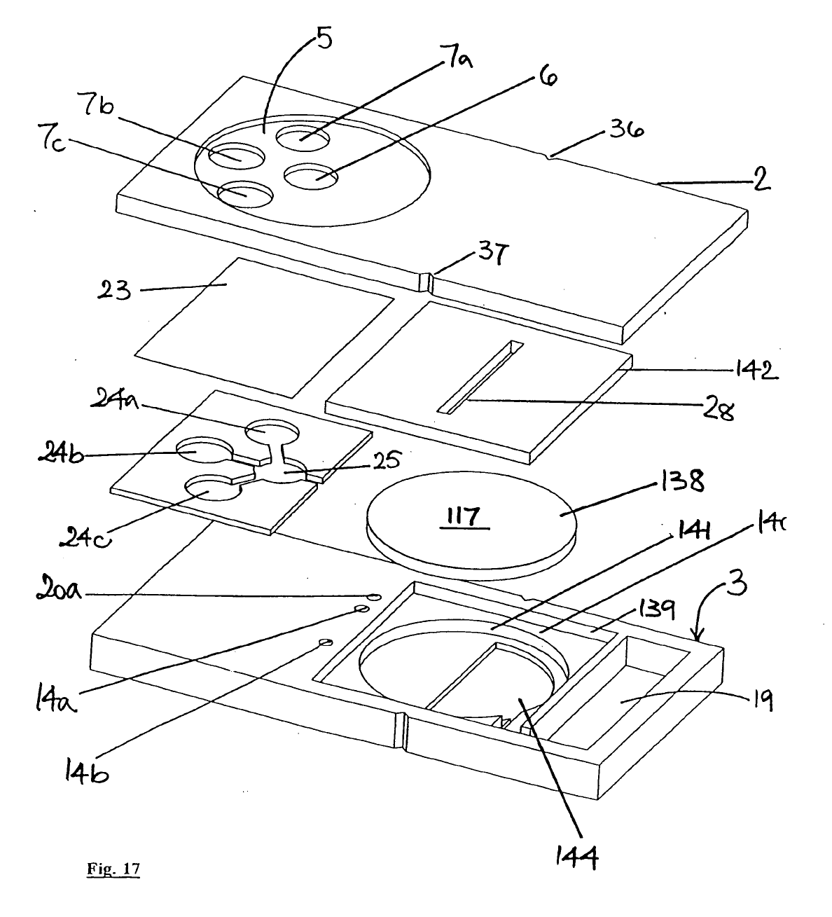

FIG. 16 is a perspective view from above of a second embodiment of the invention;

FIG. 17 is an exploded view of the device of FIG. 16;

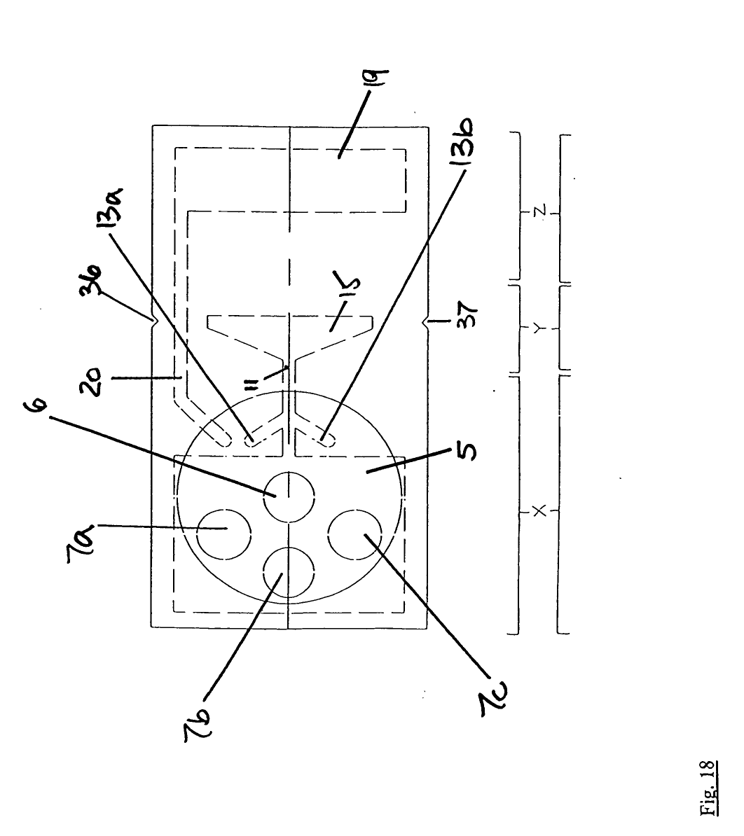

FIG. 18 is a plan view from above of a first, upper member of the device of FIG. 16;

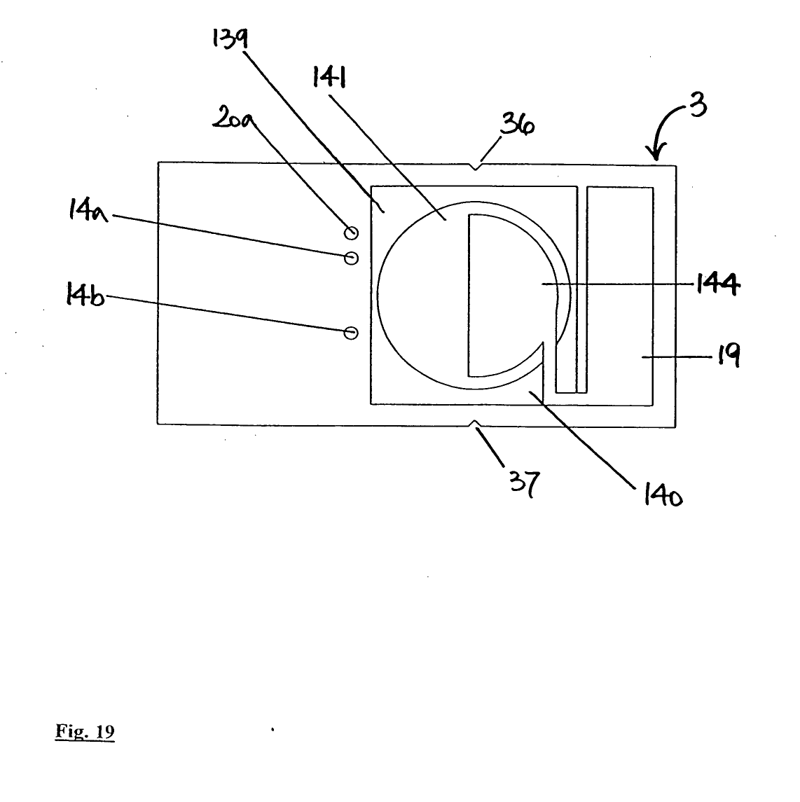

FIG. 19 is a plan view from above of a second, lower member of the device of FIG. 16;

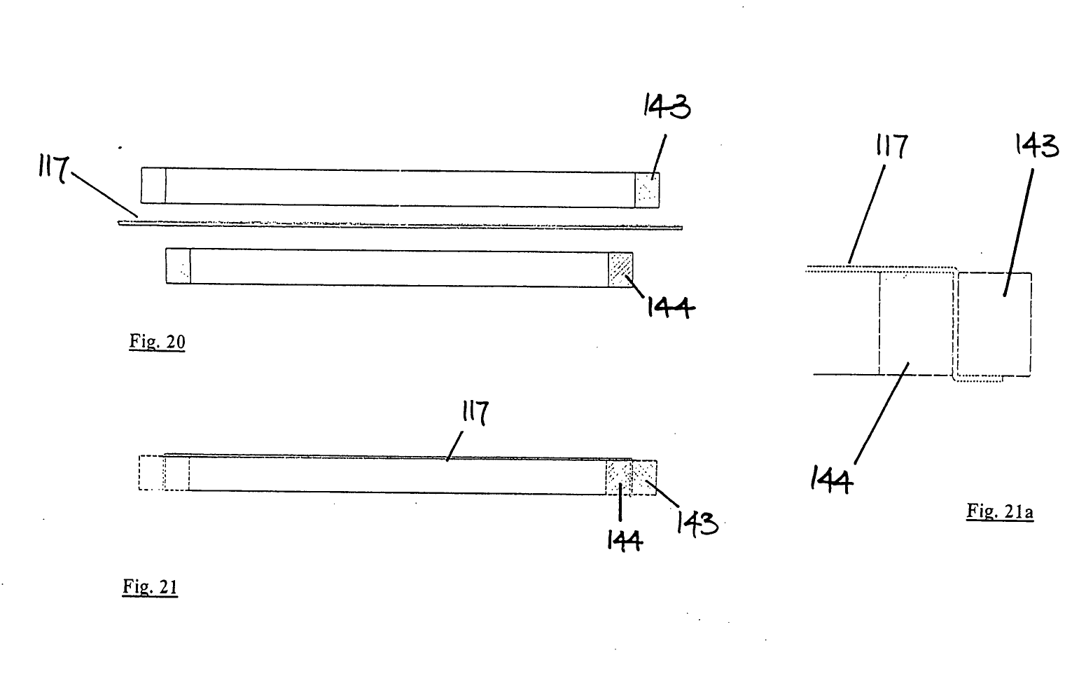

FIG. 20 is an exploded sectional view of a porous membrane and support structure for use in the device of FIG. 16;

FIG. 21 shows in section the membrane and support structure of FIG. 20 in assembled form;

FIG. 21a is a detail showing a portion of an edge of the assembly of FIG. 21.

With reference to FIG. 1, there is shown a device 1 for laying down cells on a substrate. The device 1 comprises first member 2 and a second member 3. The first member 2 is of generally rectangular shape having two opposed side edges 2a and two opposed end edges 2b. In the vicinity of one end of the first member 2 is an upwardly extending annular wall 4, the inner surface of which is provided with a screw thread (not shown). The annular wall 4 encloses a circular portion 5 of the outer surface of member 2. A circular aperture 6 is located centrally in the circular portion 5. Three further circular apertures, 7a, 7b and 7c are located eccentrically in the circular portion 5 (aperture 7c is not visible in the view of FIG. 1 but is shown in FIG. 2).

The second member 3 is of generally rectangular shape with two opposed side edges 3a and two opposed end edges 3b. An annular wall 8 extends downwardly from the member 3 and is provided on its outer side with a screw thread (not shown). The first member 2 and second member 3 cooperate to define an interior test labyrinth as will be described further below.

The device 1 is in the form of a slide. It is suitable for examination of the substrate using a microscope, or other suitable visualisation instrument. Furthermore, it is suitable for use with a corresponding screw-top container, as described further below with reference to FIG. 15.

FIG. 2 is a plan view of the device of FIG. 1, showing in broken lines features of the interior test labyrinth. The test labyrinth can be generally divided into three portions, namely, a sample delivery portion X, a central portion Y in which the main function is separation of suspended cells from a fluid sample, and a filtrate disposal portion Z in which the residual fluid after removal of the cells is stored and/or expelled. Commencing in the delivery portion X, apertures 7a, 7b, 7c communicate via filters 9a, 9b and 9c and channels 10a, 10b, 10c with a passageway 11. Aperture 6 also communicates via filter 12 with passageway 11, which is of height approximately 1 mm and width approximately 2 mm. Passageway 11 extends longitudinally along the device towards the central portion Y. Confluent channels 13a, 13b, 13c, 13d join the passageway 11 upstream of the central region Y. Channels 13a, 13b, 13c, 13d in the second member 3 communicate by means of orifices 14a, 14b, 14c, 14d with the outside of second member 3. The orifices 14a to 14d are each closed by self-seal membranes.

In the central region Y, the passageway 11 has a portion 15 that flares sharply outwardly towards an edge 16, which extends across the passageway and delimits the bottom wall thereof. The flared portion is approximately 25 mm wide at the edge 16, and has a height of 1 mm. Downstream of edge 16 is a portion of porous substrate 17. Although not visible in FIG. 2, the substrate is recessed slightly from the edge 16. A further passageway 18 leads from underneath the substrate 17 to a reservoir 19. The passageway 18 has at its upstream end a tapered portion for collecting liquid-filtrate from the substrate. An outlet passageway 20 leads from the reservoir 19 to an outlet aperture 20a in the delivery portion X of second member 3. If desired, a flexible membrane may be provided in the member 2 over a portion of the outlet passageway 20 such that the passageway 20 can be temporarily closed by pressing on the flexible membrane. Where present, such a temporary closure means in the outlet passageway 20 may permit the user of the device to stop the flow of fluid through the device.

Referring now to FIG. 3, which is a section along A-A in FIG. 2, between the first member 2 and second member 3 are located a first insert 21, a second insert 22, a filter sheet 23 and a sheet 32 of a porous membrane including elongate portion 17. The first insert 21, which is described in detail below with reference to FIGS. 11 and 12, is generally planar and includes three circular through-holes forming chambers 24a, 24b and 24c which, in the assembled device, are coaxial with, but axially displaced from, the apertures 7a, 7b and 7c. Only chamber 24b is visible in FIG. 3. The insert 21 also includes a further chamber 25, which in the assembled device is coaxial with, but displaced from, the aperture 6. The chambers 24a, 24b, 24c and 25 are separated from the apertures 7a, 7b and 7c 6 by portions 9a, 9b, 9c and 12 of the filter sheet 23, which is held in position by the inner surface of first member 2 and the opposing surface of insert 21. The mouths of the chambers 24a, 24b, 24c and 25 in the opposite surface 21b of insert 21 are closed by the abutting inner surface of second member 3. The filter sheet is suitable for separating from entrant fluid particles of relatively large particle size. The filter sheet advantageously has pores of diameter 50 μm or more, preferably at least 200 μm or more, and serves to remove from the fluid any large particles or particle aggregates that might block the porous substrate. The chambers 24a, 24b, 24c and 25 provide an enlarged area (in comparison with passageway 11) to enable effective filtration to occur. Channel 10b (also shown in FIG. 1) connects chamber 24b with through-hole 25. The outlet of channel 10a is also visible in FIG. 3 in the wall of chamber 25. Passageway 11 extends from chamber 25 longitudinally along the device towards central portion Y and its wall is interrupted by the outlets of channels 13a, 13b, 13c and 13d (shown in FIG. 2—but only 13c and 13d can be seen in FIG. 3).

As will be further described below, the channels 13a to 13d may be primed, before use of the device, with one or more labelling materials for labelling target cells. The labelling material may, for example, be incorporated in the channels during manufacture in the form of a preparation attached to the channel walls. The channels may each contain the same or different materials. It will be appreciated that any other substance which may be useful in preparation or visualisation of the sample may be included in the channels 13a to 13d as well as, or instead of, labelling materials.

Between the first and second members in central portion Y of the device is the second insert 22, which is fixedly attached to the second member 3, but spaced from the inner surface of first member 2. The upstream portion of insert 22 has a surface 26 that is gently inclined upwardly in the direction in which the fluid will, in use, flow. (Such an upwardly inclined floor region is not essential, and indeed it may be preferred for the floor of the passageway to be flat. The insert 22 in the device described merely serves for convenient location of the substrate.) The insert 22 also has a horizontal portion 27. An elongate aperture 28, extending transversely across the device, is provided in the portion 27, and frames the portion 17 of the porous substrate that, in use, is to receive the cells. The aperture is delimited at its upstream extremity by an upper edge 29 on the upper surface of insert 22. The upper edge 29 corresponds-to the edge 16 referred to above with reference to FIG. 2. At the edge 29, a wall 30 extends downwardly. A corresponding vertical wall 31 is provided internally upon the second member 3. The wall 30 and wall 31 are arranged to form a substantially continuous vertical surface except for interruption by the sheet of porous membrane 32, which is held in place by the second insert 22 and the second member 3. The porous membrane 32 has pores of size from about 8 μm with about 100,000 per cm². Suitable materials for the membrane 32 include polycarbonate, nitrocellulose and polyester. The pores are preferably relatively uniformly distributed, but that is not essential and satisfactory results are obtainable with membranes having a random distribution of pores. Passageway 18 has at its upstream end a transversely extending elongate portion 33 located beneath the aperture 28, and a tapered portion extends downstream therefrom into the main part of passageway 18, only a portion of which can be seen in FIG. 3. The reservoir 19 for receiving the liquid filtrate is defined by cooperating recesses in members 2 and 3.

Referring to FIG. 4, the apertures 6, 7a, 7b and 7c provide inlet means for a sample of fluid. As may be seen from FIG. 4, fluid which enters via apertures 6, 7a, 7b and 7c will be filtered by filters 12, 9a, 9b and 9c, respectively, before it enters the passageway 11 via respective chamber 25, 24a, 24b or 24c in the insert 21.

FIG. 5 is an exploded view of the device of FIG. 1. In the view of FIG. 5, the annular walls 4 and 8 are not included for simplicity.

FIG. 6 shows the configuration of the inner surface of the first member 2. The features of that configuration have been described above, with reference to FIG. 1 or FIG. 3 and the same reference numerals are used in FIGS. 1, 3 and 6 for those features.

With reference to FIG. 7, the structure of the features on the inner surface of member 2 are shown in broken lines. FIG. 8 is a plan view from above of the member 2, in which the features on the underneath surface are indicated by broken lines.

FIGS. 9 and 10 are a side view and plan view, respectively, of the member 3, with hidden features being indicated by broken lines.

FIGS. 11 and 12 show the insert 21, whilst FIGS. 13 and 14 show the insert 22. As mentioned above, the insert 22 defines an elongate aperture 28, the length of which corresponds to the width of the outlet of the flared portion 15 of passageway 11. The aperture 28 frames the portion 17 of the porous substrate that will receive the fluid sample. In practice, the aperture may be 25 mm long and 2 mm wide and the portion of porous substrate so framed has of the order of 50,000 pores. It will be appreciated that the references herein to length of the aperture 28 refer to the dimensions in a direction extending transversely across the device.

Referring to FIG. 15a, an especially preferred embodiment of the invention includes a device according to FIG. 1 in combination with a container 33 and a lid 34 which is screw-threadedly engageable with the neck of the container 33. The device 1, the container 33 and the lid 34 are each so dimensioned and configured that, when the lid is removed from the container, the lid can be screw-threadedly engaged with annular wall 4 and the container can be screw-threadedly engaged with annular wall 8. The container is of a size suitable for receiving a 20 ml sample in the embodiment shown.

FIG. 15b shows the device of FIG. 15a before inversion to initiate cell separation. It will be appreciated that the fluid containing the cytological sample will first be made up in the container 33, which may then be closed by screw-top lid 34. Subsequently, the lid can be removed and replace by the device 1, to the opposed side of which the lid 34 may then be attached. On inversion of the container and device, cells are laid down on the substrate, which is located in the laterally extending portion 35 of device 1. That portion 35 can be examined using a microscope, or subjected to any other suitable visualisation technique.

In use of the device of FIGS. 1 to 14, a fluid sample containing the particles (in the case of the device shown, cells) is introduced into the apertures 6, 7a, 7b and 7c. For example, where the device is as described with reference to FIG. 15, the container (which is attached to annular wall 4) may be inverted. Alternatively, the access apertures may be covered by a sealable membrane, through which the sample may be injected, for example, using a syringe, or by a lid which is removable to permit introduction of the sample by any suitable means.

The fluid enters the chambers 25, 24a, 24b and 24c via the filters 12, 9a, 9b and 9c, which filter out large particle size contaminants. The coarsely filtered fluid then flows via passageways 10a, 10b and 10c and passageway 11 towards the central portion Y of the device. Material suitable for labelling selected particles may be introduced into the sample via the corresponding channels 13a to 13d. If desired, the inner wall surfaces of channels 13a to 13d may be primed before use with a suitable labelling composition, which may be drawn out of the channels 13a to 13d as the fluid passes those channels. If desired or necessary, a suitable washing liquid may be injected through the self-seal membrane closing the respective orifice 14a to 14d to wash the pre-loaded labelling composition. In addition, to previously loaded material in the channels 13a to 13d, or instead, suitable labelling material may be injected using a syringe or similar device through the self-seal membranes that close orifices 14a to 14d. Suitable labelling material may include, for example, antibiotics, in combination with marker means, for example, one or more substances selected from chromogens, coloured beads, magnetic beads, paramagnetic beads and reporter molecules. The sample becomes well mixed with any added materials as it passes along the passageway 11. As the fluid flows along the flared portion 15 of passageway 11 it spreads transversely, apparently filling the entire width of the passageway and the advancing face of the fluid eventually reaches the edge 29, at which it spills over onto the substrate.

On impact upon the elongate portion 17 of the porous substrate, the liquid medium and small particles of, for example, less than 8Am, will pass through the porous membrane whilst particles of 8Am diameter or more are retained thereon. In practice, it has been found that there is a tendency for one particle to be retained in the mouth of each pore. It is further believed that, as pores in the vicinity of the wall become substantially closed to liquid flow because of the presence of the retained particles, the sample fluid flows over that portion of the membrane with those retained particles and is similarly filtered by the next substantially unobstructed portion of the membrane. It is important that, in use of the device described for separating cells, it is possible to obtain upon the portion 17 of the porous membrane a layer of cells which is, or is substantially, a monolayer. As a result, it is possible to examine the supported cells, in situ upon the membrane. The cells may be observed, and relevant characteristics determined, using any suitable visualisation techniques. Suitable visualisation techniques may include, for example, optical or electronic techniques.

The internal volume of the device described is a little under 2000 mm³, consisting of 384 mm³ upstream of membrane 17 and 1546 mm³ downstream of membrane 17. A fluid sample volume of about 200 mm³ is suitable for obtaining a satisfactory supported cell sample for examination.

In the embodiment shown in FIG. 15, the fluid sample is caused to flow through the device as a result of gravity. Instead, or as well, the device may include means allowing the sample to be blown into the device or sucked through the device.

For the avoidance of doubt, references herein to “downwardly” are to be understood as referring to the orientation when the device is in use. In certain forms of device, such as that described with reference to FIG. 15, the device may normally be kept in a position which is inverted with respect to the position in which the device is placed to effect separation and laying down of the cells. That is to be disregarded when construing the word downwardly where it is used herein.

Another form of device 100 according to the invention is shown in FIGS. 16 to 21a, in which the same reference numerals are used for parts corresponding to parts of the device of FIGS. 1 to 14.

Referring to FIG. 16, the external aspects of the device differ from the device of FIGS. 1 to 14 in that there is no wall surrounding the apertures 6, 7a, 7b and 7c, the circular area 5 instead being recessed slightly with respect to the surrounding part of the member 2; there is no depending annular wall on the underside of the device; and the device has first and second opposed location indents 36, 37, which can serve to locate the device correctly in a reading port of a suitable visualisation device, such as a microscope. The first member 2 and second member 3 of the device 100 are of optically transmissive material, and the device 100 is in the form of a slide.

With reference to FIGS. 17 and 18, the sample delivery portion X of the test labyrinth within device 100 is of identical structure to the test labyrinth of device 1 except that there are in device 100 only two channels, indicated by reference numerals 13a and 13b, for delivery of reagents. The channels 13a, 13b have corresponding orifices 14a , 14b.

Referring to FIG. 17, the structure of central region Y differs from that of the device of FIGS. 1 to 14 in that a porous membrane 17 extends relatively tautly across an annular support device 138, discussed in more detail below with reference to FIGS. 20, 21 and 21a. The second member 3 is provided with a square recess 139 having a base 140 in which is provided a further, circular recess 141. The annular support device 138 is, in the assembled device, received snugly within circular recess 141. A square member 142 fits snugly into the square recess 139, the lower surface of member 142 being in abutment with the upper face of porous membrane 117 and with the surrounding base 140 of recess 139. An elongate aperture 28 is provided in the member 142 framing a portion of membrane 117 that, in use, is to receive the cells. In the base of circular recess 141 is a further, semicircular recess 144, which communicates via a drainage channel 145 with reservoir 19.

Referring to FIG. 20, porous member 117 is maintained under relatively uniform tension by means of supporting it on an annular support device 138 which consists of two annular plastics rings 143, 144. Ring 144 has an external diameter which is such that that ring can be nested in snap-fit fashion within ring 143, with the periphery of membrane 117 clamped between the rings 144 and 143 as shown in FIG. 21 and, in detail, in FIG. 21a.

The membrane 117 has pores of size from about 8 μm at a distribution density of about 100000 per cm². Suitable materials are those indicated above with reference to membrane 17 of device 1.

The operation of the device 100 is essentially the same as that of device 1. For introduction of a sample of fluid, the inverted slide 100 may be placed over a container of the fluid with the container mouth against the circular recessed area 5 (which may be expediently be covered with a material that gives a good seal with the container rim), and the container and slide 100 then turned over together so as to deliver fluid into the slide 100. The membrane support structure 138 of the device 100 has been found to offer advantages in terms of reproducibility of the tensioning of the porous membrane and in terms of simplicity of manufacturing.

The passageway 11 and the substrate 17, 117 are each arranged to extend substantially horizontally in use of the device. In that context “substantially horizontally” is to be understood as including a slight incline of, for example, up to 15° and preferably no more than 10° from precisely horizontal. In practice, such a slight incline can be advantageous in permitting the escape of bubbles which might otherwise collect under the porous substrate. Whilst devices in which the passageway extends substantially horizontally in use could nonetheless be used to lay down cells when arranged such that the passageway extends at a larger angle to the horizontal, including vertically, that will in general result in less even distribution of the particles on the substrate and may be disadvantageous in terms of extra apparatus required as a consequence of the need to subject the device to higher suction or pressure to cause the fluid to flow through the device.

The following Examples illustrate the invention:

### EXAMPLE

A cervical smear sample, taken in standard fashion, was transferred into a vial of 20 ml of preservative fluid (CYTOLYT—manufactured by Cytyc) immediately after being taken. A haemocytometer was used to estimate the concentration of the solution, found to be approximately 5×10⁵ cells per ml of the solution. 0.2 ml of this solution (approximately 100,000 cells) was removed to use for the experiment, and was added to a further 1 ml of the preservative fluid. Antibodies, which were suitable for specifically binding to the squamous cells and carried a fluorescent marker, were then added and the mixture left to incubate for an hour. 0.2 ml of the sample was then sucked through a slide according to the invention.

The slide used included a central portion that was essentially as described above with reference to FIGS. 1 to 15, but incorporated modified inlet means and outlet means. As inlet means there was provided a first syringe (syringe A), the plunger of which had been removed, for injecting the sample directly into the passageway 11. As outlet means, a second syringe (syringe B) was provided for withdrawing residual liquid through an output aperture in a downstream portion of passageway 18.

Before introduction of the sample, the plunger of syringe B was in the closed position. Using a pipette, the sample was then introduced into syringe A which, as already mentioned, had no plunger present. The fluid was slowly drawn through the slide by withdrawing the plunger in syringe B.

The membrane was viewed with a fluorescence microscope using 10× magnification. Individual cells were clearly visible on the membrane. The majority of cells were not touching adjacent cells, which suggests that a monolayer of cells was achieved. The cells were also distributed evenly across the whole membrane. The membrane pores could also be seen under the microscope.

In this Example there were used antibodies for binding specifically to the squamous cells to illustrate the laying down of a monolayer cells. It will be appreciated that, in clinical use, there will be used as well or instead antibodies which are suitable for binding specific cells to columnar cells and/or binding specifically to transformation zone cells offering the possibility of determining quantitatively or qualitatively the presence of those cells and thus the possibility of deforming adequacy of the cervical smear sample.

1-43. (Cancelled)

44. A device for laying down particles on a substrate, comprising a porous substrate and delivery means for delivering to the porous substrate a sample of fluid that contains the particles, the delivery means comprising an inlet for the fluid, and a passageway extending along a first direction from the inlet towards the porous substrate, the passageway being so arranged that it permits flow of the fluid generally along a first direction towards the substrate whilst further permitting spreading of the fluid in a direction transverse to the first direction.

45. A device according to claim 44 in which the porous substrate extends substantially parallel to an upper surface of the device and the arrangement is such that the passageway can deliver the sample onto the porous substrate from above.

46. A device for preparation of a layer of particles for subsequent optical examination, comprising a slide member enclosing a flow arrangement which includes a porous substrate at least a planar upper surface of which extends substantially horizontally within and along a portion of the slide member, the flow arrangement further comprising an inlet for a fluid sample that contains the particles, and a passageway extending from said inlet for delivery of the sample onto said upper surface of said porous substrate.

47. A device according to claim 44, in which at least a part of the passageway is flared outwardly.

48. A device according to claim 44, in which the passageway extends substantially horizontally in use of the device.

49. A device according to claim 44, in which the passageway comprises an outlet communicating with the porous substrate for delivery of the sample thereto, and at least that part of the passageway that is in the vicinity of the outlet is flared outwardly.

50. A device according to claim 44, in which the passageway comprises an outlet communicating with the porous substrate for delivery of the sample thereto, and at least that part of the passageway that is in the vicinity of the outlet is flared outwardly, wherein the outlet is positioned above the porous substrate in use of the device.

51. A device according to claim 44, in which the passageway comprises an outlet communicating with the porous substrate for delivery of the sample thereto, and at least that part of the passageway that is in the vicinity of the outlet is flared outwardly, wherein the outlet is positioned substantially vertically above the porous substrate in use of the device.

52. A device according to claim 44, in which the passageway comprises an outlet communicating with the porous substrate for delivery of the sample thereto, and at least that part of the passageway that is in the vicinity of the outlet is flared outwardly, wherein the outlet for the fluid includes a wall that extends towards the porous substrate, whereby the porous substrate can receive fluid which, in use, flows from the outlet via the wall.

53. A device according to claim 44, in which the passageway comprises an outlet communicating with the porous substrate for delivery of the sample thereto, and at least that part of the passageway that is in the vicinity of the outlet is flared outwardly, wherein the outlet for the fluid includes a wall that extends towards the porous substrate, whereby the porous substrate can receive fluid which, in use, flows from the outlet via the wall, which extends downwardly.

54. A device according to claim 44, in which the passageway comprises an outlet communicating with the porous substrate for delivery of the sample thereto, and at least that part of the passageway that is in the vicinity of the outlet is flared outwardly, wherein the outlet for the fluid includes a wall that extends towards the porous substrate, whereby the porous substrate can receive fluid which, in use, flows from the outlet via the wall, in which the wall is of elongate configuration, having a longitudinal dimension that is greater than a transverse dimension, the wall being so located that its longitudinal dimension extends generally transversely to the direction of flow of the fluid down the wall.

55. A device according to any one of claim 44, in which the passageway comprises an outlet communicating with the porous substrate for delivery of the sample thereto, and at least that part of the passageway that is in the vicinity of the outlet is flared outwardly, wherein the outlet for the fluid includes a wall that extends towards the porous substrate, whereby the porous substrate can receive fluid which, in use, flows from the outlet via the wall, in which the passageway comprises a base that terminates at the wall.

56. A device according to claim 44, in which the passageway comprises an outlet communicating with the porous substrate for delivery of the sample thereto, and at least that part of the passageway that is in the vicinity of the outlet is flared outwardly, wherein the outlet for the fluid includes a wall that extends towards the porous substrate, whereby the porous substrate can receive fluid which, in use, flows from the outlet via the wall, in which the passageway further comprises opposed side walls that diverge from one another along at least a part of the passageway in the direction in which, in use, the fluid flows.

57. A device according to claim 44, in which the passageway is enclosed.

58. A device according to claim 44, in which there is a drainage receptacle for receiving fluid that has passed through the porous substrate.

59. A device according to claim 44, which further comprises a reagent-delivery channel through which a reagent can be delivered into the delivery means.

60. A device according to claim 44, which further comprises from two to six reagent-delivery channels through each of which a reagent can be delivered into the delivery means.

61. A device according to claim 44, which further comprises one or more reagent-delivery channel through which a reagent can be delivered into the delivery means, in which the one or more reagent-delivery channel communicates with a respective access opening through which reagent can be introduced into the device.

62. A device according to claim 44, which comprises a selective binding moiety, the arrangement being such that in use the fluid sample can contact the selective binding moiety before it is delivered to the porous substrate.

63. A device according to claim 44, which comprises a selective binding moiety in combination with marker means for acting as an indicator of any selectively bound binding moiety that is retained upon the porous substrate in use of the device, the arrangement being such that in use the fluid sample can contact the selective binding moiety before it is delivered to the porous substrate.

64. A device according to claim 44, which has a total internal void volume of not exceeding 20 ml.

65. A device according to claim 44, which has a total internal void volume of not exceeding 4 ml.

66. A device according to claim 44, which has a total internal void volume of not exceeding 20 ml in which the internal void volume of the device upstream of the porous substrate is not more than 0.75 ml.

67. A device according to claim 44, which has a total internal void volume of not exceeding 20 ml in which the internal void volume of the device upstream of the porous substrate is not more than 0.4 ml.

68. A device according to claim 44, in which the passageway has an outlet of width at least 10 mm.

69. A device according to claim 44, further comprising a fluid container, the passageway and the substrate being located within a member that can be attached to the fluid container.

70. A device according to claim 44, further comprising a fluid container, the passageway and the substrate being located within a member that can be attached to the fluid container, in which the arrangement is such that a fluid sample from the container can be introduced into the passageway by means of partially or wholly inverting the container and member.

71. A device according to claim 44, which comprises a membrane through which a fluid sample can be injected into the device.

72. A device according to claim 44, in which the porous substrate has pores of diameter not more than 50 μm.

73. A device according to claim 44, in which the porous substrate has pores, in which the pore diameter is in the range of from 0.05 to 20 cm.

74. A device according to claim 44, in which the porous substrate has pores, in which the pore diameter is in the range of from 1 to 15 μm.

75. A device according to claim 44, in which the porous substrate has pores, in which the pore diameter is in the range of from 2 to 10 μm.

76. A device according to claim 44, in which the porous substrate has pores, in which the pore diameter is in the range of from 10 to 20 μm.

77. A device according to claim 44, in which the particles are cells.

78. A device according to claim 77, in which at least that part of the device containing the passageway and that part of the porous substrate upon which the cells are to be laid down is transparent to radiation.

79. A device according to claim 77, which is so arranged that at least that part of the device that in use will contain the loaded porous substrate can be inserted into a sample cavity of an instrument for analysis of the cells using radiation.

80. A device according to claim 44, which is so arranged that at least that part of the device that in use will contain the loaded porous substrate can be inserted into the viewing region of a device for visual inspection.

81. A device according to claim 44, which comprises a filter for filtering a sample of fluid that is to enter the passageway.

82. A method of laying down particles comprising passing a sample of fluid along a substantially horizontal passageway that flares outwardly permitting the flow of fluid so obtained to fall onto an upper face of a porous substrate and draining away from a lower face of the porous substrate residual fluid that has passed therethrough.

83. A method according to claim 82, in which a sample of fluid of volume not exceeding 0.5 ml is brought into contact with a porous substrate over an area of at least 20 mm².

84. A method according to claim 82, in which the particles are cells.

85. A method according to claim 84, in which there is combined with the fluid sample before entry to or in the passageway at least one marker that is capable of marking target cells present in the fluid sample.

86. A method according to claim 85, in which the marker comprises antibodies.
